(19) United States
(12) Patent Application Publication
(10) Pub. No.: US 2026/0202834 A1
(43) Pub. Date: Jul. 16, 2026

(54) In-line screwing method and method for controlling screwing operations

(71) Applicant: ETABLISSEMENTS GEORGES RENAULT, SAINT HERBLAIN (FR)

(72) Inventors: Régis LE MAULF, SAINT HERBLAIN (FR); Julien TROPEE, NANTES (FR); Vincent BOUSSARD, SAINT HERBLAIN (FR)

(21) Appl. No.: 19/137,863

(22) PCT Filed: Dec. 6, 2023
(86) PCT No.: PCT/EP2023/084571

§ 371 Date: Jun. 11, 2025

(30) Foreign Application Priority Data
Dec. 16, 2022 (FR) FR2213544

(51) Int. Cl. G05B 19/418; B23P 19/06

(52) U.S. Cl. CPC G05B 19/41875; B23P 19/065; G05B 19/41805; G05B 2219/37572; G05B 2219/45203

(57) ABSTRACT

A method for screw driving and quality control of screw driving operations on a production line having a succession of workstations. The method includes at least: carrying out at least one screw driving operation on a structure to be assembled at at least some of the workstations, each screw driving operation carried out at a workstation being carried out via a screw driving device dedicated to the corresponding station and screw driving operation; quality control of the at least one screw driving operation, which is carried out at a workstation after the workstation where the verified screwing operation was carried out. The quality control is carried out via a screw driving device dedicated to the later station.

### 1. CROSS-REFERENCE TO RELATED APPLICATIONS

This Application is a Section 371 National Stage Application of International Application No. PCT/EP 2023/084571, filed Dec. 6, 2023, and published as WO 2024/126215 A1 on Jun. 20, 2024, not in English, which claims priority to and the benefit of French Patent Application No. FR2213544, filed Dec. 16, 2022, the contents of which are incorporated herein by reference in their entireties.

### 2. FIELD OF THE INVENTION

The field of the invention is that of methods for carrying out on-line screw driving operations and operations of controlling the quality of screw driving operations.

### 3. PRIOR ART

In various industrial sectors, in particular such as that of motor vehicle manufacturing, it is known to implement assembly lines 1 along which several workstations P1, P2, Px are set up. A structure to be assembled 10, for example such as a motor vehicle, an engine, a transmission or other, is moved along the assembly line 1 to undergo at the various stations one or more screw driving operations. After the screw driving operations have been carried out, the structure to be assembled is transported to a quality control station Pc where operators control, via a torque wrench specifically intended for quality control, all or a part of the screw driving operations carried out at the various stations to ensure that they satisfy one or more predetermined quality criteria. Alternatively, screw driving operations can be controlled on-line directly at the workstations by operators also via a torque wrench specifically intended for quality control.

During the quality control of a screw driving operation, a torque wrench is used to apply a tightening torque to the screw, the screw driving of which is controlled. When the torque reaches a value called slip torque, the screw begins to turn. This torque is representative of the quality of the screw driving. The operator must then immediately stop driving the screw in order to not overtighten it and risk having a negative effect on the quality of the screw driving and/or inflict damage.

For reasons of productivity, only a certain number of screw driving operations are controlled. In practice, the most critical screw driving operations are controlled and the controlling thereof gives a statistical image of the quality of all of the screw driving operations carried out.

Although such an approach may allow to control in a rather efficient manner the quality of the screw driving operations carried out during screw driving operations, it can be further optimised.

Indeed, such an approach consisting in controlling the quality of successive screw driving operations after the last screw driving operation has been carried out does not allow in particular to detect an anomaly in a screw driving operation as soon as it occurs and consequently take the necessary corrective measures, for example such as:
correcting the defective screw driving operation on the line before continuing the carrying out of the following screw driving operations or sending the assembly with a defective screw driving operation to a correction station;
replacing the defective tool on the line by a tool in a functioning state and sending the defective tool for maintenance;
etc.

This control method according to the prior art does not therefore allow to take into consideration in an anticipated manner the occurrence of a screw driving anomaly rapidly after it occurs and draw therefrom the teachings that will allow to correct the situation as fast as possible in order to guarantee the quality of the screw driving operations and the productivity with which they are carried out.

Moreover, this control method imposes the implementation, in addition to the workstations dedicated to carrying out screw driving operations, of a workstation dedicated only to quality control. This tends to make the structure of the assembly lines more complex and has a negative effect on productivity since it is necessary to wait until all the screw driving operations have been carried out before starting the control thereof.

Moreover, whether the operations of quality control are carried out at a final control station or directly at the workstations, they are carried out by using specific control tools, in particular such as torque wrenches. These control tools are added to the screwdrivers implemented to carry out screw driving operations and thus the carrying out of the screw driving operations and the control thereof supposes the use of a significant number of tools to be acquired, handled and maintained in a functioning state.

Moreover, the technique consisting in controlling the quality of a screw driving operation via a torque wrench supposes the development of a specific know-how by an operator that implements it. Indeed, the operator must develop a dexterity them immediately stop the driving of the screw, the screw driving of which is being controlled as soon as the wrench “disengages” in order to not induce an overtightening during the control.

There is therefore a need to improve the techniques for controlling the quality of screw driving operations.

### 4. SUMMARY

For this, the invention proposes a method for screw driving and controlling the quality of screw driving operations, on a production line comprising a succession of workstations, said method comprising at least:
a step of carrying out at least one screw driving operation on a structure to be assembled at at least some of said workstations, each screw driving operation carried out at a workstation being carried out via a screw driving device dedicated to the corresponding station and screw driving operation;
a step of quality control of said at least one screw driving operation.

According to the invention, the step of quality control of a screw driving operation is carried out at a workstation after the workstation where said controlled screw driving operation was carried out, said step of quality control being carried out via the screw driving device dedicated to said later station.

Thus, according to this aspect, the invention involves:
rather than using a specific tool like a torque spanner to carry out the control operations, using for this purpose screw driving tools, and
rather than waiting for the structure to be assembled to pass all of the workstations so that all the screw driving operations are carried out before carrying out the quality control of at least some screw driving operations, carrying out the quality control of at least some screw driving operations at one or more workstations after that or those at which they were carried out. Moreover, the control operations carried out at a station are carried out via the screw driving tool dedicated to this station.

This approach allows:
to reduce the number of tools implemented to carry out the screw driving operations and the controls since the control are carried out with screw driving tools, at least some of which are capable of being implemented to also carry out screw driving operations;
to carry out the quality controls earlier and thus detect a possible anomaly earlier and draw therefrom the conclusions in comparison to the cases of the prior art in which the control operations are carried out at a final workstation;
to reduce the risk of overtightening during the quality control or at the very least to reduce the level thereof.

In the prior art, the number of quality controls carried out after the completion of all the screw driving operations is relatively limited so as to not reduce the productivity. Via the implementation of the invention, it is possible to carry out control operations on workstations at which the operators have a little down time once they have carried out the screw driving operations that must be carried out at these stations, to further carry out one or more control operations. The use of this down time at certain workstations to carry out control operations in advance thus allows to increase the number of controls carried out without having a negative effect on the productivity.

According to one possible feature, said screw driving operations are carried out at predetermined screw points of said structure to be assembled, and said control operations are carried out at predetermined control points of said structure to be assembled, a control point of a quality control operation corresponding to a screw point at which a screw driving operation was previously carried out.

According to one possible feature, each screw driving device dedicated to a workstation is programmed to carry out at this workstation at least one screw driving operation and/or at least one control operation at the corresponding screw or control points.

According to one possible feature, the order in which the operations to be carried out at a workstation are carried out is predetermined.

According to one possible feature, said method comprises, before each of said steps of carrying out a screw driving operation and of the steps of carrying out a control operation are carried out, a step of geolocation of said corresponding screw driving device, with respect to said screw points and/or said control points of said structure to be assembled, a screw driving operation adapted to the corresponding screw point and/or a control operation adapted to the corresponding control point being activated when said screw driving device is located at said corresponding screw point and/or at said corresponding control point.

According to one possible feature, a method according to the invention comprises:
a step of masking said screw points and/or said control points, and
in a manner substantially synchronous with the activation in said screw driving device of a screw driving operation or of a control operation, a step of freeing the access by said screw driving device to the screw point or to the control point corresponding to said activated screw driving operation or activated control operation, all of the other screw points and control points other than that at which the screw driving operation or control activated must be carried out being masked to remain inaccessible to said screw driving device.

According to one possible feature, a method according to the invention comprises, in a manner substantially synchronous with the activation in said screw driving device of a screw driving operation or of a control operation, a step of illuminating the corresponding screw point or control point where said activated operation must be carried out.

According to one possible feature, a method according to the invention comprises, during the carrying out of each step of carrying out a screw driving operation, an optional step of detecting an overtightening illustrating that the screw driving operation is carried out on a screw driving previously carried out rather than on a screw driving to be carried out.

According to one possible feature, a method according to the invention comprises, after a screw driving operation, a step of measuring at least one parameter representative of the quality of the screw driving carried out, a step of verifying the presence of the value of said at least one parameter in a first predetermined tolerance interval, then a step of generating a first screw driving report.

According to one possible feature, each quality control operation comprises:
a step of driving the screwed element in the direction of the screw driving during the screw driving operation to be controlled;
a step of detecting, during the previous step, the slipping of said screwed element with respect to said structure to be assembled;
a step of stopping said step of driving after detection of said slipping;
a step of measuring the value of the slip tightening torque reached during the stopping of said step of driving;
a first step of verifying the presence, in a second predetermined tolerance interval, of said slip tightening torque, said first step of verifying being followed by a step of generating a second report;
a second step of verifying the presence, in a third predetermined tolerance interval, of said slip tightening torque reached during the stopping of said step of driving, said second step of verifying being followed by a step of generating a third report.

According to one possible feature, a method according to the invention comprises the emission of a consolidated report taking one or more of the first, second and third reports.

According to one possible feature, each of said quality control operations is recorded with an identifier associated with the identifier of the corresponding screw driving operation controlled.

The invention also covers a computer program product that can be downloaded from a communication network and/or stored on a support readable by computer and/or executable by a microprocessor, said computer program product comprising program code instructions for the execution of a method according to any one of the above alternatives, when it is executed by a computer.

### 5. DESCRIPTION OF THE DRAWINGS

Other features and advantages of the invention will appear upon reading the following description of specific embodiments, given as a simple illustrative and non-limiting example, and the appended drawings among which:

FIG. 1 illustrates an assembly line according to the prior art;

FIG. 2 illustrates an example of an assembly line according to the invention;

FIG. 3 illustrates a general example of the method according to the invention;

FIG. 4 illustrates a detailed example of a method according to the invention;

FIGS. 5, 6, 7 illustrate optional blocks of a method according to the invention.

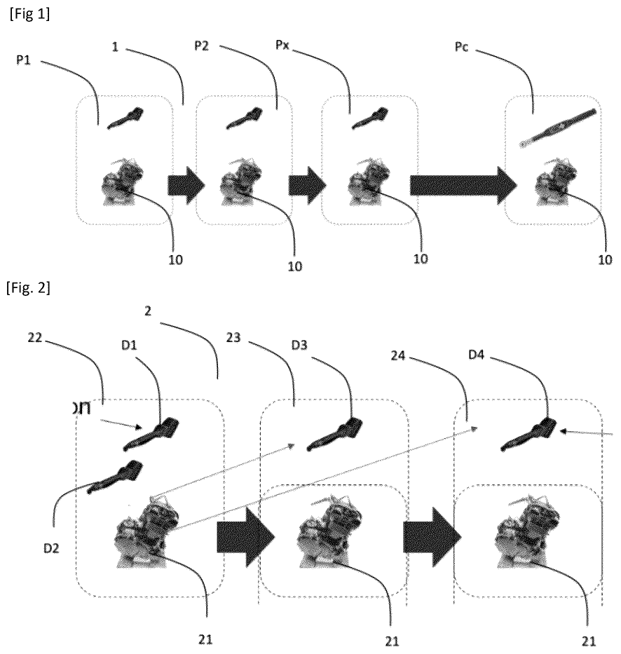

### 6. DESCRIPTION OF SPECIFIC EMBODIMENTS

### 6.1. General Structure of an Assembly Line

An example of an assembly line 2 along which a structure to be assembled 21 is capable of being moved to undergo a plurality of screw driving operations and quality control operations is presented in relation to FIG. 2.

Such an assembly line 2 conventionally comprises a plurality of workstations. In the example illustrated, the assembly line comprises three workstations 22, 23, 24. In alternatives, it can comprise at least two workstations.

Each workstation is dedicated to carrying out, on the structure to be worked on, at least one screw driving operation. Each screw driving operation is carried out on a screw point of the structure to be worked on. The structure to be worked on thus has as many screw points as there are screw driving operations to be carried out on it.

At least some workstations are dedicated to carrying out, on the structure to be worked on, at least one operation of controlling the quality of at least one screw driving operation carried out at a preceding workstation. Each quality control operation is carried out on a control point of the structure to be worked on. A control point at a later workstation corresponds to a screw point at an earlier station.

Although this is not optimal, some workstations could be intended only for carrying out one or more quality control operations and not for further carrying out one or more screw driving operations.

Each workstation is provided with at least one screw driving device D1, D2, D3, D4. A screw driving device is preprogrammed to carry out, at the station to which it is dedicated, at least one screw driving operation. It can further be preprogrammed to carry out one or more control operations of the screw driving quality carried out during the carrying out of screw driving operations at one or more later workstations.

The screw driving operations are carried out at predetermined screw points of the structure to be assembled. The control operations are carried out at predetermined control points of the structure to be assembled. A control point of a quality control operation corresponds to a screw point at which a screw driving operation was previously carried out.

### 6.2. Example of a Method According to the Invention

### 6.2.1. Organisation of the Operations of Screw Driving and Quality Control at the Workstations

An exemplary embodiment of a method according to the invention for screw driving and quality control of screw driving operations, on a production line comprising a succession of workstations, will now be described.

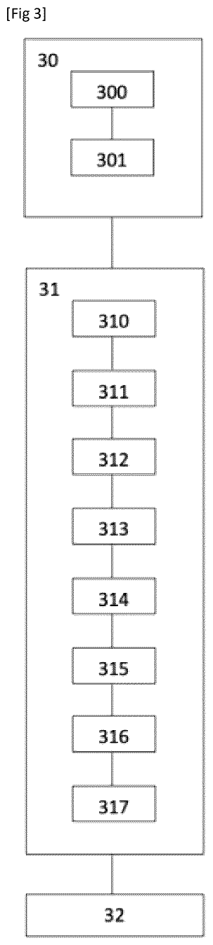

In general, such a method comprises at least (cf. FIG. 3):
a step 30 of carrying out at least one screw driving operation on a structure to be assembled at at least some of the workstations;
a step 31 of quality control of at least some of said screw driving operations.

At least some of the quality control steps are carried out at a workstation after the workstation where the controlled screw driving operation in question was carried out, each quality control step being carried out via a screw driving device dedicated to the later station where it was carried out. At least one screw driving operation is carried out at the later station where at least one quality control operation is carried out. It is however possible that at one or more workstations, the screw driving tool(s) dedicated thereto are only used to carry out control operations.

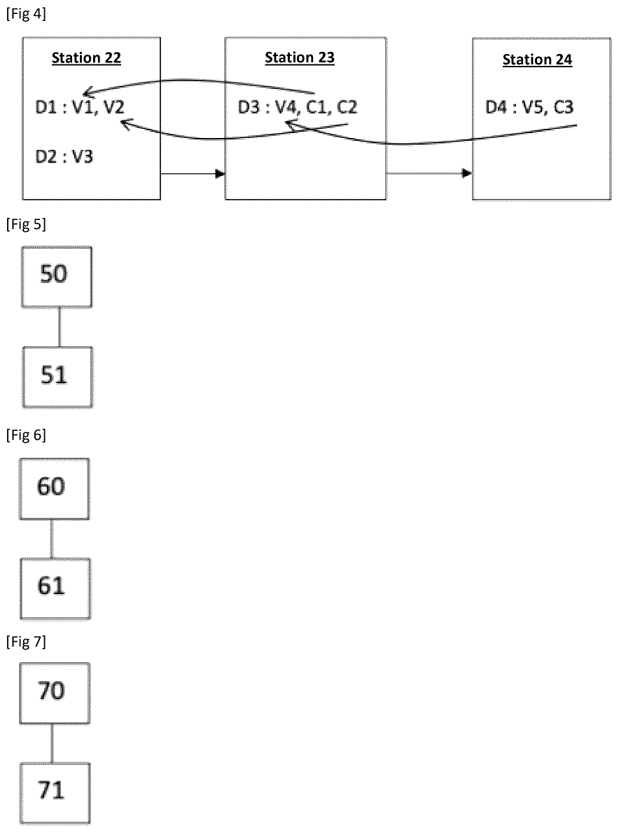

In the example described, in reference to FIG. 4:
at the first workstation 22 a first screw driving operation V1 and a second screw driving operation V2 via a first screw driving device D1 dedicated to the first workstation and a third screw driving operation V3 via a second screw driving device D2 dedicated to the first workstation must be carried out;
at the second workstation 23 a fourth screw driving operation V4 via a third screw driving device D3 dedicated to the second workstation as well as a first operation C1 of controlling the first screw driving and a second operation C2 of controlling the second screw driving via the third screw driving device D3 dedicated to the second workstation must be carried out;
at the third workstation 24 a fifth screw driving operation V5 via a fourth screw driving device D4 dedicated to the third station and a third operation C3 of controlling the fourth screw driving via the fourth screw driving device D4 dedicated to the third station must be carried out.

This is merely a possible example and all other alternatives are possible. In particular, there could be one or more stations dedicated only to control even if this is not optimal.

Each screw driving device dedicated to a workstation is programmed to carry out at this workstation at least one screw driving operation and/or at least one control operation at the corresponding screw or control points.

### 6.2.2. Implementation of a Sequencing of Operations

A method according to the invention can implement an operation sequencing.

In this case, each screw driving device dedicated to a workstation is programmed to carry out at this workstation operations of screw driving and/or control at the corresponding screw or control points, the screw driving and/or control operations being programmed in the screw driving device according to a predetermined order.

In other words, a screw driving device at a workstation is programmed to successively carry out for example a first screw driving operation, a second screw driving operation, a first control operation then a third screw driving operation.

After each screw driving and control operation has been carried out, a screw driving or control report is emitted.

An assembly line is provided with control means, like an assembly line robot, a controller or other, which allows, when the structure to be assembled arrives at a workstation, to activate the first screw driving or control operation in the screw driving device. The operator thus carries out the first screw driving or control operation then, after the report of the first operation has been emitted, the control means activate in the screw driving device the second screw driving or control operation. The operator carries out this second operation after which a report is emitted. The operations thus succeed each other until all of the operations to be carried out at this station are completed. The control means then order the movement of the structure to be assembled to a later station where the operations that must be carried out there are completed in turn. The process is repeated until the structure to be assembled arrives at the end of the assembly line.

In the example described here, at the first workstation 22:
the first screw driving device D1 is programmed to carry out, in a sequenced manner, the first screw driving operation V1 on a first screw point of the structure to be assembled then the second screw driving operation V2 on a second screw point of the structure to be assembled, and
the second screw driving device D2 is programmed to carry out the third screw driving operation V3 on a third screw point of the structure to be assembled.

At the second workstation 23, the third screw driving device D3 is programmed to carry out, in a sequenced manner, the fourth screw driving operation V4 on a fourth screw point of the structure to be assembled, then the first quality control operation C1 on a first control point of the structure to be assembled corresponding to the first screw point, then the second quality control operation C2 on a second control point of the structure to be assembled corresponding to the second screw point.

At the third workstation 24, the fourth screw driving device D4 is programmed to carry out, in a sequenced manner, the fifth screw driving operation V5 on a fifth screw point of the structure to be assembled, then the third quality control operation C3 on a third control point of the structure to be assembled corresponding to the fourth screw point.

When the structure to be assembled arrives at the first station 22:
the control means activate in the first screw driving device D1 the first screw driving operation V1 that the operator carries out on a first screw point of the structure to be assembled then, after the emission of the report of the first operation,
the control means activate in the first screw driving device D1 the second screw driving operation V2 that the operator carries out on a second screw point of the structure to be assembled after which a report of the second operation is emitted, and
the control means then activate in the second screw driving device D2 the third screw driving operation V3 that the operator carries out on a third screw point of the structure to be assembled after which a report of the third operation is emitted.

After the emission of the report of the third operation, the control means order the movement of the structure to be assembled to the second workstation 23. They then activate in the third screw driving device D3 the fourth screw driving operation V4 that the operator carries out on a fourth screw point of the structure to be assembled, then after the emission of the report of the fourth screw driving operation, the control means activate the first quality control operation C1 that the operator carries out on a first control point of the structure to be assembled corresponding to the first screw point. After the emission of the report of the first control operation, the control means activate in the third screw driving device D3 the second quality control operation C2 that the operator carries out on a second control point of the structure to be assembled corresponding to the second screw point.

After the emission of the report of the second control operation, the control means order the movement of the structure to be assembled to the third workstation 24. The control means then activate in the fourth screw driving device D4 the fifth screw driving operation V5 that the operator carries out on a fifth screw point of the structure to be assembled, then after the emission of the report of the fifth screw driving operation, the control means activate in the fourth screw driving device D4 the third quality control operation C3 that the operator carries out on a third control point of the structure to be assembled corresponding to the fourth screw point. The assembly ends after the emission of the report of the third control operation.

When the operations must be carried out according to a predetermined sequencing, the operator in charge of carrying them out is preferably previously trained to know the order for carrying out the operations.

### 6.2.3. Implementation of a Geolocation

A method according to the invention can implement a geolocation of the screw driving devices with respect to the structure to be assembled.

Means for geolocating screw driving devices with respect to the screw points and the control points of the structure to be assembled at the various workstations are thus implemented. These geolocation means can be of various types for example they can use one or more infrared cameras fastened above the workstation and a first tag provided with infrared LEDs fastened onto the tool and a second tag of the same type fastened onto the structure to be assembled. Moreover, the means for controlling the camera are capable of calculating from the image of the tags captured by the camera the position of the screw driving device and of the structure to be assembled in the coordinate system of the camera then calculating the relative position of the screw driving device with respect to the structure to be assembled. It is thus possible to deduce therefrom at which screw or control point the tool is located. Such a technique is for example described in the patent document WO2021259523.

In this case, the method comprises (cf. FIG. 5), before each of the steps of carrying out a screw driving operation and of the steps of carrying out a control operation are carried out, a step 50 of geolocating the corresponding screw driving device, relative to the screw points and/or the control points of the structure to be assembled, a screw driving operation adapted to the corresponding screw point and/or a control operation adapted to the corresponding control point being activated in an activation step 51 when the screw driving device is located at the corresponding screw point and/or control point.

The geolocation means installed at a station on a screw driving device are preferably connected to the control means of the assembly line to provide them with the information on the screw or control point where the screw driving device is located and consequently allow the control means to activate the screw driving or control strategy adapted to the screw or control point at which the screw driving device is located.

In the embodiment described here, this principle could be implemented for example in the following manner.

Although in alternatives all the screw driving devices of all the workstations are not necessarily provided with such a device, in the example described here, all the screw driving devices are provided with geolocation means.

Moreover:
when the control means detect the presence of the structure to be assembled at the first workstation 22, the control means activate:
   in the first screw driving device D1:
      a first screw driving strategy when the geolocation means detect that its screw driving tip is located at the first screw point, and
      a second screw driving strategy when the geolocation means detect that its screw driving tip is located at the second screw point;
   in the second screw driving device D2 a third screw driving strategy when the geolocation means detect that its screw driving tip is located at the third screw point;
when the control means detect the presence of the structure to be assembled at the second workstation 23, the control means activate in the third screw driving device D3:
a fourth screw driving strategy when the geolocation means detect that its screw driving tip is located at the fourth screw point;
   a first control strategy when the geolocation means detect that its screw driving tip is located at the first control point, and
   a second control strategy when the geolocation means detect that its screw driving tip is located at the second control point;
when the control means detect the presence of the structure to be assembled at the third workstation 24, the control means activate in the fourth screw driving device D4:
   a fifth screw driving strategy when the geolocation means detect that its screw driving tip is located at the fifth screw point, and
   a third control strategy when the geolocation means detect that its screw driving tip is located at the third control point.

In one alternative, the control means can impose onto the operator an order for carrying out the various operations to be carried out at a station, the control means blocking the screw driving device if the operator does not respect an order of carrying out the operations. The operator will have been previously trained as to the order to be followed.

### 6.2.4. Implementation of a Masking

A method according to the invention can implement a masking of screw points and/or control points.

In this case, a masking device is implemented at the workstation(s) involved. Such a masking device can consist of a physical screen placed between the operator and the structure to be assembled. This screen is provided with a flap actuatable by the control means of the assembly line to give access to the screw or control point according to the desired order.

In this case, the method comprises (cf. FIG. 6), at at least some of the workstations in a manner substantially synchronous with the activation in the screw driving device of a screw driving operation or of a control operation during an activation step 61, a step 60 of freeing the access by the screw driving device to the screw point or to the control point corresponding to the screw driving or control operation activated, all of the other screw points and control points other than that at which the screw driving or control operation activated must be carried out being masked to remain inaccessible to the screw driving device.

In the embodiment described here, this principle could be implemented for example at the second station 23 only in the following manner:
the control means of the assembly line control the masking device (not shown) to free the access to the third screw point only, then to the first control point only then to the second control point only;
the control means of the assembly line activate in the third screw driving device D3 the fourth screw driving strategy when the fourth screw point only is not masked, the first control strategy when the first control point only is unmasked and the second control strategy when the second control point only is not masked.

### 6.2.5. Implementation of an Illumination

A method according to the invention can implement an illumination of screw points and/or of control points.

In this case, illumination means are implemented. Such illumination means can consist of a laser spot, the orientation of the beam of which can be controlled by the control means of the assembly line to illuminate the screw or control points according to the desired carrying-out order. The orientation of the beam is synchronised with the activation of the screw driving or control strategies in the screw driving devices by the control means.

In this case, the method comprises (cf. FIG. 7), at at least some of the workstations in a manner substantially synchronous with the activation in the screw driving device of a screw driving operation or of a control operation during an activation step 71, a step 70 of illuminating the corresponding screw point or control point where the activated operation must be carried out.

In the embodiment described here, this principle could be implemented for example at the third station 24 only in the following manner:
the control means of the assembly line control an illumination device (not shown) to illuminate the fifth screw point only, then to illuminate the third control point only;
the control means of the assembly line activate in the fourth screw driving device D4:
the fifth screw driving strategy when they order the illumination of the fifth screw point;
the third control strategy when the order the illumination of the third control point.

### 6.2.6. Implementation of a Detection of Overtightening

A method according to the invention can implement a detection of possible overtightening of certain screw points.

In this case, the method comprises, during the carrying out of each step 30 of carrying out a screw driving operation, an optional step 300 of detecting an overtightening illustrating that the screw driving operation is carried out on a tightening previously carried out rather than on a tightening to be carried out.

As an example, if the third screw driving operation V3 is carried out at the first station 22 by mistake at the second screw point previously tightened, rather than at the third screw point, the second screw point will be overtightened. Such an overtightening can be detected, for example in the following way in a manner known in the prior art involving controlling the angle of rotation of the screw, the screw driving of which must be controlled, until the target tightening torque is reached. In the case of a screw driving, the angle of rotation is several tens of degrees whereas in the case of an overtightening, the angle will be several degrees.

### 6.2.7. First Screw Driving Report

A method according to the invention can comprise steps of generating, after each of the screw driving steps, a first screw driving report.

A first screw driving report can comprise the result of recording of at least one parameter illustrating the quality of a screw driving, for example such as the tightening torque and/or the tightening angle.

The strategy of each screw driving operation comprises a tolerance interval for each parameter illustrating the quality of the corresponding screw driving.

A first screw driving report comprises, besides the value of the parameter(s) illustrating the quality of the screw driving, an indication of the “ok/not ok” type indicating for each interval whether the corresponding parameter is properly located therein.

### 6.2.8. Second and Third Screw Driving Reports

It is known to implement operations of controlling the quality of a screw driving called slip control operations.

A slip control involves, after a screw driving operation, applying to the screw a screw driving torque. When this torque is close to the final tightening torque, the screw begins to rotate, i.e. to slip. The torque measured at the moment of the slipping of the screw is the slip torque, the value of which is representative of the final tightening torque.

A method according to the invention can comprise a step of generating 310, after each of the steps of control 31, a second and a third screw driving report.

In this case, each quality control operation comprises:
a step 310 of driving the screwed element in the direction of the screw driving during the screw driving operation to be controlled;
a step 311 of detecting, during the preceding step 310, the slipping of the screwed element with respect to the structure to be assembled, i.e. separation of the screwed element with respect to the structure to be assembled; the slipping occurs when the torque applied, during the control, onto the already tightened screw, reaches the torque at which the screw was previously tightened;
a step 312 of stopping the step of driving 311 after detection of the slipping; this driving is a little sudden since its only goal is to allow the detection of the slipping. This driving must be as short as possible to limit the overtightening and the use of a screw driving device for this purpose rather than a torque wrench provides an advantage since the amplitude of this overtightening is managed by the control means of the screw driving device which are by nature more reactive than the user of the torque wrench who themself manually controls the amplitude of this overtightening;
a step 313 of measuring the value of the slip tightening torque reached during the stopping of the step of driving 310;
a first step 314 of verifying the presence, in a first predetermined tolerance interval, of the slip tightening torque, the first step of verifying 314 being followed by a step 315 of generating a second report;
a second step 316 of verifying the presence, in a second predetermined tolerance interval, of the slip tightening torque reached during the stopping of the step of driving 310, the second step of verifying 316 being followed by a step 317 of generating a third report.

A report can be the torque or angle value reached and an OK or NOK meaning that this value is in the corresponding interval or not.

### 6.2.9. Consolidated Reports

A method according to the invention can comprise a step 32 of emitting a consolidated report taking one or more of the first, second and third reports.

Such a consolidated report could be a synthesis of the three reports bringing together the various parameters measured and the indication that they are located in the corresponding tolerance intervals or not.

### 6.2.10. Other Aspects and Advantages

According to one possible alternative, each of the quality control operations is recorded with an identifier associated with an identifier of the corresponding screw driving operation controlled. This allows to ensure traceability.

A screw driving can undergo, during a certain time after it is carried out, a phenomenon of relaxation resulting in that the final tightening torque at which it was carried out can reach a later lower stabilised final value. Thus, if a screw driving that undergoes a relaxation is controlled before the relaxation takes place, its quality can be considered as acceptable although it may not be after relaxation. Thus, moving the quality control of a screw driving carried out at an earlier station to a later station can allow to avoid this disadvantage.

On an assembly line, it happens that the number of operations to be carried out at certain workstations is smaller and/or that the time necessary to carry out these operations is shorter. Thus, the operator in charge of these stations has a little “free” time. This “free” time can be used according to the invention to carry out quality control operations on-line rather than at a final control station as provided for in the prior art. Thus, the invention allows to increase productivity. It can also allow to increase the number of quality controls carried out which allows to have a statistical image of the quality of the operations truer to reality. Thus, if only 5% of the products are controlled according to the prior art, the costs of the quality are reduced, but a doubt remains for 95% of the products. Increasing the frequency/the population of products controlled according to the invention allows to reduce the risk of not achieving a zero-defect delivery by using mainly down time (free time).

The invention allows to avoid the use of a station dedicated exclusively to quality control, which contributes to simplifying assembly lines.

Carrying out quality controls upstream and not at a final station can allow to detect upstream a possible deviation bringing to light a defectiveness of one or more screw driving devices having been implemented to carry out screw driving operations not satisfying the required level of quality.

It is possible for the quality of an earlier screw driving to be influenced by a neighbouring later screw driving carried out nearby. In this case, it is preferable to control the quality of the earlier screw driving after the later neighbouring screw driving has been carried out, which is allowed by the invention.

The technique according to the invention allows to avoid the use of screwdrivers of the prior art comprising two torque sensors, one allowing to detect that the final tightening torque has been reached and trigger the stoppage of the screw driving and the other allowing to carry out a quality control of the screw driving, such an approach having the disadvantages of not allowing to take into account the influence of a possible relaxation of the screw driving or of a neighbouring tightening.

The evaluation in real time of the quality of the screw driving operations, in particular by a technique of measuring residual separation torques, allows a constant monitoring of the production, in advance of the quality measurements. The implementation of an automatic statistical process control (SPC) allows actions of preventive maintenance (readjustments of tools/repairs) and the identification of the root causes. The implementation of a quality alert in advance can allow an analysis of the root causes/the adoption of a process of assistance or replacement of a qualified machine.

An exemplary aspect of the present disclosure provides an effective solution to at least some of these various problems.

In particular, an exemplary aspect provides a technique for carrying out successive screw driving operations and quality control of the screw driving operations that is efficient and economical.

In particular, an exemplary aspect of the present disclosure avoids the occurrence of an overtightening during a quality control operation by poor use by an operator of the torque wrench implemented for this purpose.

An exemplary aspect of the present disclosure provides such a technique that can allow the detection of an anomaly in a screw driving operation as early as possible.

In particular, an exemplary aspect of the present disclosure provides such a technique that can allow to launch preventive actions of maintenance of the tools implemented to carry out screw driving operations after an anomaly has been detected in a screw driving operation.

An exemplary aspect of the present disclosure provides such a technique that can allow to increase the number of quality controls carried out on assemblies without leading to a drop in productivity.

Another aspect of the disclosure provides such a technique that is simple to implement and/or reliable and/or economical.

Although the present disclosure has been described with reference to one or more examples, workers skilled in the art will recognize that changes may be made in form and detail without departing from the scope of the disclosure and/or the appended claims.

1. A method for screw driving and controlling a quality of screw driving operations, on a production line comprising a succession of workstations, said method comprising at least:
carrying out at least one screw driving operation on a structure to be assembled at at least some of said workstations, each screw driving operation carried out at a workstation being carried out via a screw driving device dedicated to the corresponding station and screw driving operation;
performing a quality control operation of said at least one screw driving operation, referred to as a verified screw driving operation,
wherein the quality control operation of the verified screw driving operation is carried out at a later workstation after the workstation where said verified screw driving operation was carried out, said quality control operation being carried out via a screw driving device dedicated to said later workstation.

2. The method according to claim 1, wherein said screw driving operations are carried out at predetermined screw points of said structure to be assembled, and said quality control operations are carried out at predetermined control points of said structure to be assembled, a control point of a quality control operation corresponding to a screw point at which a screw driving operation was previously carried out.

3. The method according to claim 2, wherein each screw driving device dedicated to a workstation is programmed to carry out at this workstation at least one screw driving operation and/or at least one control operation at the corresponding screw or control points.

4. The method according to claim 3, wherein an order in which the screw driving and/or quality control operations to be carried out at a workstation are carried out is predetermined.

5. The method according to claim 3, said method comprising, before each of said carrying out a screw driving operation and of performing a control operation are carried out, a step of geolocation of said corresponding screw driving device, with respect to said screw points and/or said control points of said structure to be assembled, a screw driving operation adapted to the corresponding screw point and/or a control operation adapted to the corresponding control point being activated when said screw driving device is located at said corresponding screw point and/or at said corresponding control point.

6. The method according to claim 3, comprising:
masking said screw points and/or said control points, and
in a manner substantially synchronous with activation in said screw driving device of a screw driving operation or of a control operation, a step of freeing access by said screw driving device to the screw point or to the control point corresponding to said activated screw driving operation or activated control operation, all of the other screw points and control points other than that at which the activated screw driving operation or activated control operation must be carried out being masked to remain inaccessible to said screw driving device.

7. The method according to claim 3, or comprising, in a manner substantially synchronous with an activation in said screw driving device of a screw driving operation or of a control operation, illuminating the corresponding screw point or control point where said activated operation must be carried out.

8. The method according to claim 1, comprising, during the carrying out of each screw driving operation, detecting an overtightening illustrating that the screw driving operation is carried out on a screw driving previously carried out rather than on a screw driving to be carried out.

9. The method according to claim 1, comprising, after screw driving operation, measuring at least one parameter representative of a quality of the screw driving carried out, verifying a presence of the value of said at least one parameter in a first predetermined tolerance interval, then a generating a first screw driving report.

10. The method according to claim 1, wherein each quality control operation comprises:
a step of driving a screwed element in the direction of the screw driving during the screw driving operation to be verified;
a step of detecting, during the step of driving, slipping of said screwed element with respect to said structure to be assembled;
a step of stopping said step of driving after detection of said slipping;
a step of measuring a value of a slip tightening torque reached during the stopping of said step of driving;
a first step of verifying a presence, in a second predetermined tolerance interval, of said slip tightening torque, said first step of verifying being followed by a step of generating a second report;
a second step of verifying a presence, in a third predetermined tolerance interval, of said slip tightening torque reached during the stopping of said step of driving, said second step of verifying being followed by a step of generating a third report.

11. The method according to claim 10, comprising, after the screw driving operation, measuring at least one parameter representative of a quality of the screw driving carried out, verifying a presence of the value of said at least one parameter in a first predetermined tolerance interval, then generating a first screw driving report, and
comprising emission of a consolidated report taking one or more of the second and third reports.

12. The method according to claim 1, wherein each of said quality control operations is recorded with an identifier associated with an identifier of a corresponding screw driving operation verified.

13. At least one non-transitory computer readable medium comprising instructions of a computer program product stored thereon, which when executed by at least one processor, configure the at least one processor to implement the method according to claim 1.
